(19) United States
(12) Patent Application Publication
(10) Pub. No.: US 2009/0134371 A1
(43) Pub. Date: May 28, 2009

(54) Curb box lifter

(76) Inventor: Gregory Allen Pawelk, Montrose, MN (US)

Correspondence Address: MARK STEVEN LEWANDOWSKI, 1357 WESTWOOD ROAD, HUTCHINSON, MN, 55350, US

(21) Appl. No.: 12/315,022

(22) Filed: Nov. 25, 2008

Related U.S. Application Data
(60) Provisional application No. 61/004,272, filed on Nov. 26, 2007.

(51) Int. Cl. B66F 11/00

(52) U.S. Cl. 254/120

(57) ABSTRACT

A curb box lifter comprises a frame that includes crossbar members, through holes, or partially drilled openings as points of engagement for a pry bar for the purpose of upwardly lifting water main curb boxes. The proximal end of the curb box lifter includes a pipe threaded region enabling it to be spun into a receiving female threaded curb box lid, usually situated in the ground. A pry bar introduced into the curb box lifter at its points of engagement, in conjunction with a block like device used a leverage point, enables the upward motion of the curb box as a downward force is employed to the pry bar distal end.

### RELATED APPLICATIONS

This application claims priority to U.S. Provisional Application No. 61/004,272 filed Nov. 26, 2007 which is hereby incorporated by reference in its entirety.

### BACKGROUND OF THE INVENTION

1. Field of the Invention

This invention relates to hardware tooling, and more particularly, to a device to assist with the lifting and adjustment of water main curb boxes.

2. Description of Related Art

In a municipal water system, the source of water to a building is the water main that runs beneath the street. Utility workers at a job site who are tasked with shutting off the water main to a business or residential facility need to gain access to the curb stop. Likewise, problems with the plumbing or valves inside a building can sometimes result in this valve being the only access to shut water service off in an emergency. Therefore, it is of utmost urgency that access to the curb stop is quickly gained.

A curb stop, often located at the property line, controls the flow of water to the residence or business. The curb stop is used to shut off the water for repairs, nonpayment of water bills, or flooded basements, among other things. The curb stop is buried six to eight feet below ground level. Usually there is an iron pipe leading to the surface from the curb stop that allows access to the shutoff valve in the curb stop. The bottom of the curb box is attached to this pipe and then extends to near the ground surface though occasionally it may only reach an elevation of 2 feet below the surface. Atop the curb box is the curb box lid. After clearing away the soil about the curb box lid, a threaded plug from the lid is removed revealing a female threaded region. A long-handled wrench or “key” is then inserted into the hole of the now exposed curb box lid and is used to reach the water valve below in the curb stop at the water main.

There are several different types of curb boxes and accessories. Two common categories are arch pattern curb boxes and “Minneapolis” curb boxes. Arch pattern, arch base, or Y-base curb boxes and accessories cover the curb stop, but are not connected mechanically. Minneapolis curb box lids have female threads that are machined into the bottom of a base which screws onto male threads. By threading the curb stop into the curb box, these curb boxes provide a unified valve and box assembly and are often designed to telescope up to 18 inches. “Erie Pattern” or eclipse curb boxes and accessories are also commonly available.

Curb boxes and accessories are designed for water, sewer or gas-line applications and comply with standards such as ASTM A48, Class 25. Components include water lids, sewer lids, and gas lids; centering rings, rods, stops, and arches; anchor bolts, anchor nuts, and support rings; and Minneapolis pattern valve support brackets. With curb boxes and accessories, standard lids include Erie pattern products, as well as lids that are tapped 1″, 1.25″, 1.5″, and 2″. Pentagon bolt plugs in curb box lids are designed for use with ball valve curb stops or inverted plug-type curb stops. Curb boxes and accessories also include curb box keys, pentagon keys, fire sprinkler lids, irrigation lids, and reclaimed water lids.

Present methods to raise a curb box involve wrapping a chain around the curb box lid. The other end of the chain is then wrapped about a pry bar that is then leveraged against a block in attempt to raise the curb stop. Often the chain would slip off, be readjusted, and rewrapped around the lid. It would not be uncommon for the operator to have to make 3-4 attempts to lift up a subterranean curb box lid. This method is one that is neither repeatable nor secure as the chain in use may break or slip off resulting in injury. Depending upon how deeply the curb box lid is buried, removing the dirt can be a time consuming effort as dirt around and beneath the lid must be removed to allow the chain to be positioned beneath it.

Accordingly, a need remains to aid in quickly gaining access to a curb stop to overcome the above-noted shortcomings. The present invention satisfies such a need by providing a lifting tool that is quick and easy to use, increases user safety, and is practical in design. Such a lifting tool has a threaded proximal end, and crossbar members attached between the legs of frame of the device and are used as leverage points. The simple design makes it intuitive for the end user to operate on the job site.

### SUMMARY OF THE INVENTION

In view of the foregoing background, it is therefore an object of the present invention to provide a lifting tool for raising curb boxes and the like. These and other objects, features, and advantages of the invention are provided by a U-shaped bent tubular central frame suitably sized and shaped for uniformly fitting into the receiving threaded curb box lid.

Although intended for use on city water systems, the curb box lifter may be used in other applications for raising or lowering a pipe or curb box, such as needed by gas utility companies. The tool may be used to raise the height of a curb box when used along with a pry bar and block, and by exerting enough force the user may slide the curb box to the desired height. The tool can also be used to lower the height of a curb box by hammering on top of the tool after it has been securely screwed into the curb box lid.

The aforementioned curb box lifter has a base, preferably made of a piece of steel well pipe with an outside diameter of 1 and ⅝ inches and inside diameter of 1 and ¼ inches National Pipe Thread. It is this threaded portion that engages the curb box lid. The threaded well pipe piece is welded between the legs at the terminus of a solid steel rod, or similar, that is bent 180 degrees that provides its U shaped configuration. The tubular legs of the steel rod are welded to opposing sides of the threaded well pipe. The overall length is approximately 17 inches long by 3 inches wide. To provide for strength and multiple lifting site points, the present invention consists of evenly spaced crossbars that are preferably made of steel rod which are welded horizontally between the vertical steel rods that resemble the legs of the U shaped configuration. An optional method of manufacture is to cast the entire assembly in a mold, thereby negating the need for weld joints.

To employ the curb box lifter, after locating and gaining access to the curb box lid, the pentagon plug that is located in the curb box lid is removed. The threaded end of the curb box lifter is then spun into the top of the curb box lid and advanced forward until it is fully engaged. Once secure, the proximal end of a pry bar or similar, is inserted into the curb box lifter beneath one of the crossbars. An appropriately sized block is positioned in close proximity to the curb box lifter so as to provide for a leverage pivot point for the pry bar. Depending upon the amount of force required to lift the curb box, the pry bar may be inserted into a crossbar that provides for the required lifting force. The user then applies a down ward force on the distal end of the pry bar until the curb box loosens and begins to rise. Once loose, the user then proceeds to continually apply a down ward force to the pry bar. As the curb box lifts, if desired it may become necessary for the user then to reposition the pry bar beneath a lower crossbar in able to continue the upward motion until the desired level of the curb box lid is achieved.

Occasionally curb boxes are difficult to be lifted. Causes such as rust and the like prevent the pipes from slipping loose. In such a situation, providing a downward shock force on the upper portion of the curb box lifter is called for. In an optimal configuration, a top strike plate may be welded on to the upper portion of the curb box lifter. Likewise, the strike plate may also be part of a monolithic unit having been cast from a mold, machined from a single piece of metal or similar means. The horizontal surface of the plate provides a landing for a hammer or the like with the goal of the pounding loose the engaged pipes to allow for subsequent lifting. Additionally, should the curb box lid be lifted past its desired height, it may be driven back down ward by a hammer or similar striking the plate. To encourage maximum engagement between the horizontal surface and a hammer, the horizontal surface of the strike plate may be roughened providing for a non-slip surface.

Variations of the crossbar members may be incorporated to provide for additional engagement of the pry bar such as their surface configured to have a rougher, non-slip surface. Crossbar members may be welded to the legs of the frame of the device or attached by other means. Additionally, the crossbar members may also be part of a monolithic unit from being cast from a mold, machined from a single piece of metal or similar means.

The curb box lifter tool may be constructed in various sizes or strengths depending upon the curb box lifting application or size of the curb box in use. Once welded together, the curb box lifter is one single tool with no moving parts.

An alternative to the bent tubular U-shaped configuration is to employ a cylindrically shaped solid rod with through holes evenly bored on a vertical line throughout with aforementioned externally threaded region at the proximal end. The geometry of the through holes may be of a circular configuration to match the geometry of the pry bar, or for maximum engagement, the holes may be of a geometrical configuration to match the shape of the pry bar. Likewise, the openings may not be through holes but openings bored partially into the cylindrical rod with the opening shape to be a variety of geometrical shapes such as circular, triangular, and the like. Atop the distal end of the solid rod is a surface to act as the strike plate region for engagement with an incoming hammer. Additionally, the aforementioned cylindrically shaped solid rod may be configured such as to be of a hollow tubular configuration with similar through holes and partially bored openings as earlier described. However, the hollow tube configuration does not lend itself to have a natural strike plate region. This requires a top strike plate to be attached be it threaded, welded or monolithically formed to the tubular portion of the unit.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is an isometric view showing a U shaped bent tubular style curb box lifter for curb stops and the like, in accordance with the present invention without an optional strike plate;

FIG. 2 is an isometric view showing a U shaped bent tubular style curb box lifter for curb stops and the like, in accordance with the present invention depicting an optional strike plate;

FIG. 3 is an isometric view showing a U shaped bent tubular style curb box lifter for curb stops and the like, in accordance with the present invention depicting weld locations at the interfaces between the crossbar members, strike plate, and the threaded well pipe with the frame;

FIG. 4 is an isometric view showing a bent tubular style curb box lifter with roughened cross members;

FIG. 5 is an isometric view showing a cylindrically shaped tube style curb box lifter with through holes evenly bored throughout down the vertical center line with externally threaded region at the proximal end, and strike plate affixed to the top;

FIG. 6 is an isometric view showing a cylindrically shaped solid rod style curb box lifter with through holes evenly bored throughout down the vertical center line with externally threaded region at the proximal end;

FIG. 7 is an isometric view showing a plate style curb box lifter with through holes located down the vertical center line of the device with externally threaded region attached at the proximal end;

FIG. 8 is an isometric view of a curb box lifter engaged into the curb box lid;

FIG. 9 is an isometric view of a curb box lifter depicting a hammer like device about to engage the curb box lifter strike plate;

FIG. 10 is an isometric view of a curb box lifter engaged with a pry bar that is leveraged against a block like device for the purposes of lifting the curb box into its desired position.

### DETAILED DESCRIPTION OF THE DRAWINGS

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

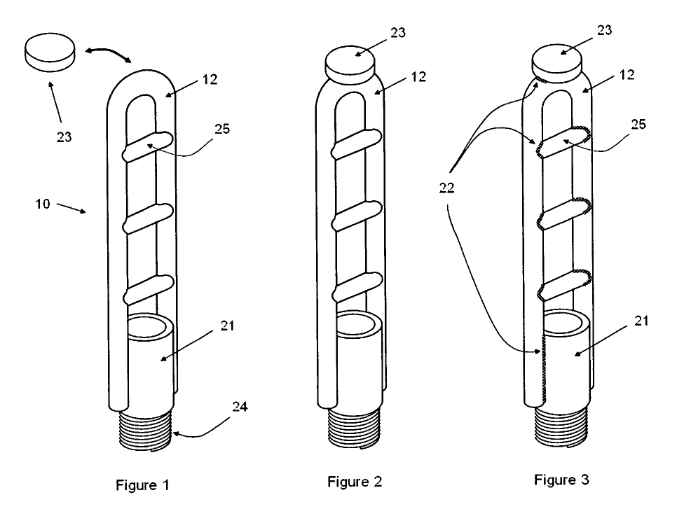

The present invention is referred to generally in FIGS. 1-10 by the reference numeral 10 and is intended to provide for lifting curb boxes and the like. It should be understood that the device 10 may be used to lift a variety of curb boxes with various female threading and should not be limited in use to only water utility curb boxes. Furthermore, it is noted that the present invention may be monolithically formed as a single unit thereby negating the necessity to mechanically attach its various parts together.

Referring initially to FIGS. 1, 2, 3, 4, 8, 9, and 10, the device 10 includes an inverted U-shaped central frame 12 suitably sized and shaped for uniformly allowing a threaded engaging piece 21, to be attached to the frame via welds 22, or similar. Threads 24 serve as the means to couple the curb box lifter 10 into the receiving curb box lid 11. Horizontal crossbar members 25 act as engagement points for pry bar 27 to lift the curb box lid. Also included in the unit is an optional strike plate 23 providing for a landing surface for an incident hammer 26 or the like. The strike plate 23 may be attached to the central frame 12 via means of threads, welds, adhesives, or similar.

FIG. 2 shows the strike plate 23 affixed to the distal end of central frame 12.

FIG. 3 shows welds 22 that are used to affix the crossbar members 25, strike plate 23, and threaded engaging piece 21 to central frame 12.

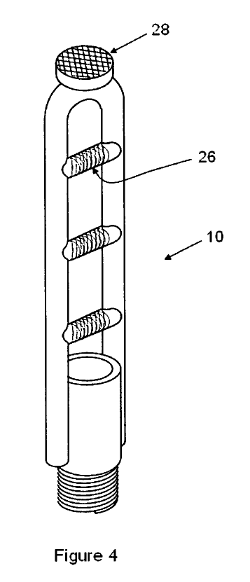

FIG. 4 shows the surface of crossbar members 26 as corrugated or roughened to provide a means to increase engagement, and thereby minimize slippage between pry bar 27 and the crossbar members 26. Strike plate 28, is shown with corrugated or roughened surface to provide a means to increase engagement between it and an incident hammer 26 or the like.

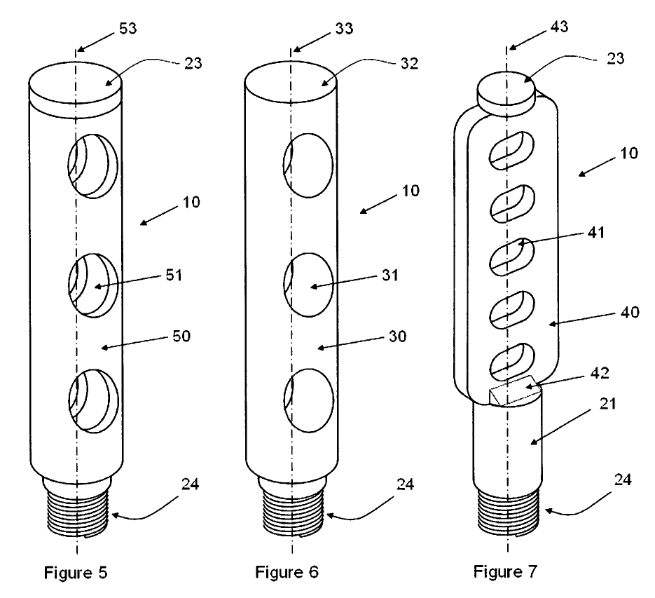

Referring to FIG. 5 the curb box lifter 10 comprises a cylindrically shaped tube 50 with through holes 51 drilled perpendicular to the central vertical axis of the rod 53. Holes 51 are dimensioned so as to accommodate the size of the proximal end of the pry bar 27. Threads 24 of appropriate size are cut into the proximal end of rod 50 so as to provide a means of engagement into curb box lid 11. Strike plate 23 is affixed to the top of the tube 50 distal end via threads, welds, adhesives or similar, providing the means of a striking surface for a hammer 26 or the like.

Referring to FIG. 6 the curb box lifter 10 comprises a solid cylindrical rod 30 with through holes 31 drilled perpendicular to the central vertical axis of the rod 33. Holes 31 are dimensioned so as to accommodate the size of the proximal end of the pry bar 27. Threads 24 of appropriate size are cut into the proximal end of rod 30 so as to provide a means of engagement into curb box lid 11. The distal end 32 of rod 30 is horizontally flat, perpendicular to the central vertical axis of the unit 33, providing the means of a striking surface for a hammer or the like.

Referring to FIG. 7, the curb box lifter 10 comprises plate 40, with through holes 41 drilled perpendicular to the central vertical axis of the plate 43. Holes 41 are dimensioned so as to accommodate the size of the proximal end of the pry bar 27. Curb box lifter 10 includes welds 42 to affix threaded engaging piece 21 to plate 40. Strike plate 23 may be attached to plate 40 via means of threads, welds, adhesives, or similar.

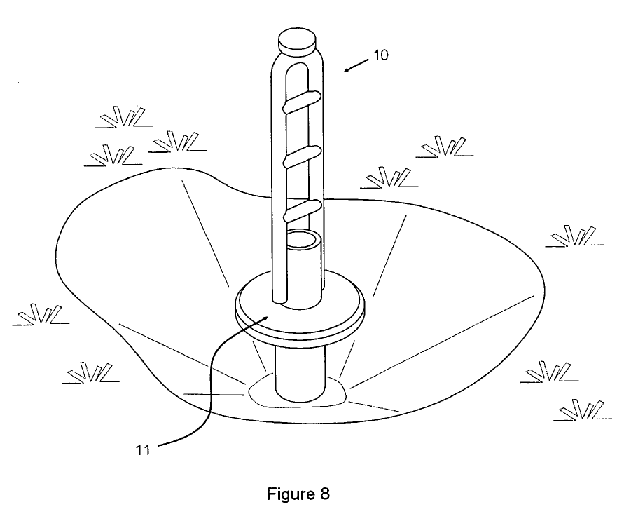

FIG. 8 shows curb box lifter 10 engaged with curb box lid 11 that has been exposed from the surrounding dirt.

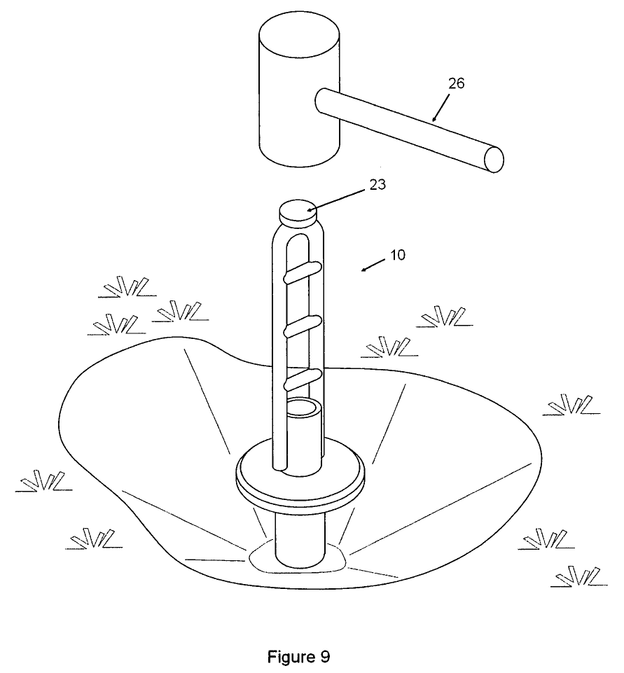

FIG. 9 shows incident hammer 26 in position to make contact with strike plate 23.

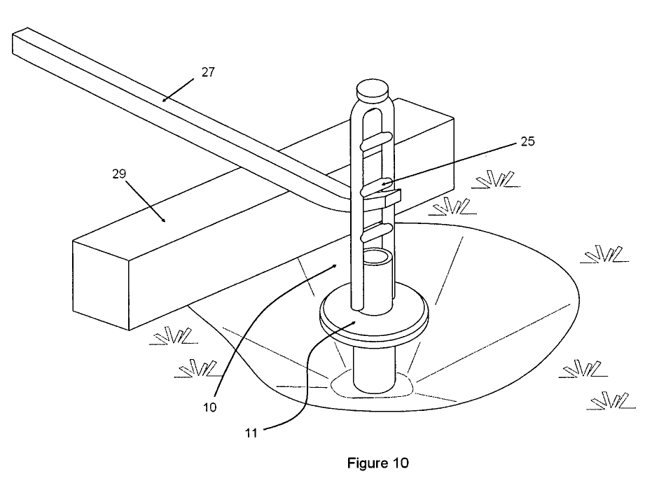

FIG. 10 shows the proximal end of pry bar 27 engaged with curb box lifter 10, at crossbar member 25 using block like device 29 as a point of leverage to raise the curb box lid 11.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

I claim:

1. A curb box lifter for assisting users to raise water main curb boxes to a desired level comprising;
a U-shaped central frame with legs affixed directly to a partially threaded member, said central frame including a plurality of crossbar members having a longitudinal length horizontally registered between said legs of said frame and directly affixed thereagainst.

2. The assembly of claim 1, wherein said plurality of crossbar members comprises shallow grooves distributed throughout said longitudinal length providing for a non-slip surface.

3. The assembly of claim 1, further comprises said plurality of crossbar members equidistantly spaced apart between the upper portion of said partially threaded member and distal end of said central frame.

4. The assembly of claim 1, further comprising said central frame includes a strike plate horizontally registered atop and directly affixed thereagainst.

5. The assembly of claim 1, further comprising said strike plate includes shallow grooves distributed throughout the upper surface providing for a non-slip surface.

6. The assembly of claim 1, wherein said partially threaded member comprises:
an upper unthreaded portion affixed to said central frame legs and a lower portion with external pipe threads located thereabout.

7. A curb box lifter for assisting users to raise water main curb boxes to a desired level comprising;
a cylindrically shaped frame, said frame including a plurality of suitably sized holes horizontally registered across the length of said frame; and
a lower portion with external pipe threads located thereabout.

8. The assembly of claim 7, wherein said holes extend through said frame.

9. The assembly of claim 7, wherein said holes extend partially into said frame.

10. The assembly of claim 7, wherein said holes include a plurality of geometric patterns.

11. The assembly of claim 7, wherein said holes equally spaced between the distal end of said frame and the upper portion of said external threads.

12. The assembly of claim 7, further comprising said frame includes a strike plate horizontally registered atop and directly affixed thereagainst.

13. The assembly of claim 7, further comprising said strike plate includes shallow grooves distributed throughout the upper surface providing for a non-slip surface.

14. A curb box lifter for assisting users to raise water main curb boxes to a desired level comprising;
a rectangular shaped central frame affixed directly to a partially threaded member, said frame including a plurality of suitably sized holes horizontally registered across the length of said frame.

15. The assembly of claim 14, wherein said holes extend through said frame.

16. The assembly of claim 14, wherein said holes extend partially into said frame.

17. The assembly of claim 14, wherein said holes include a plurality of geometric patterns

18. The assembly of claim 14, wherein said holes equally spaced between the distal end of said frame and the upper portion of said external threads.

19. The assembly of claim 14, further comprising said frame includes a strike plate horizontally registered atop and directly affixed thereagainst.

20. The assembly of claim 14, further comprising said strike plate includes shallow grooves distributed throughout the upper surface providing for a non-slip surface.

21. The assembly of claim 14, wherein said partially threaded member comprises:
an upper unthreaded portion affixed to said central frame and a lower portion with external pipe threads located thereabout.
